(19) United States
(12) Patent Application Publication
(10) Pub. No.: US 2007/0251934 A1
(43) Pub. Date: Nov. 1, 2007

(54) High Carbon Welding Electrode and Method of Welding with High Carbon Welding Electrode

(75) Inventors: Richard F. Kral, North Riverside, IL (US); Shane A. Mayhill, Crete, IL (US); Matthew Q. Johnson, Santa Fe, IL (US); Mark E. Rovnyak, Mokena, IL (US)

Correspondence Address: BARNES & THORNBURG LLP, P.O. BOX 2786, CHICAGO, IL, 60690-2786, US

(73) Assignee: Holland LP, Crete, IL (US)

(21) Appl. No.: 10/569,219

(22) PCT Filed: Apr. 22, 2005
(86) PCT No.: PCT/US05/14037

§ 371 Date: Mar. 29, 2007

Related U.S. Application Data
(60) Provisional application No. 60/564,763, filed on Apr. 23, 2004.

(51) Int. Cl. B23K 35/22

(52) U.S. Cl. 219/146.1

(57) ABSTRACT

High carbon welding electrode is used in the welding of high strength steel using gas shielded arc welding techniques whereby a plurality of beads of molten weld material join together rail ends or fill a slot in a rail for repair purposes, the high carbon electrode avoiding adjacent soft and brittle areas across a weld fusion line which result from migration of carbon from the carbon rich high strength steel to the lower carbon weld deposit.

### BACKGROUND OF THE INVENTION

1. Field of the Invention

Welding of high strength steel, particularly alloys with high carbon content through gas shielded arc welding is problematic through the creation of zones whereas carbon migrates creating local brittle and soft zones. The phenomenon being remediable by the use of welding electrode containing high carbon.

2. Description of Related Art

Steel used in high strength applications such as railroad track has a substantially uniform strength. When the ends of such material are welded through gas shielded arc welding such as that taught in U.S. Pat. No. 5,773,579, U.S. Pat. No. 5,877,868, U.S. Pat. No. 6,069,333, U.S. Pat. No. 6,166,347, U.S. Pat. No. 6,201,216, U.S. Pat. No. 6,207,920, U.S. Pat. No. 6,278,074 and U.S. Pat. No. 6,407,364. Using apparatus such as that taught in U.S. Pat. No. 6,396,020 and U.S. Application Publication No. 2002-170,884 or U.S. Pat. No. 5,605,283, strength variations across the weld fusion line are problematic.

Typical welding electrodes for joining material have a carbon content of 0.1 or less. While higher carbon content steel is known, forming that steel into welding electrode commercially is not accomplished.

Other prior art metal forming and treating techniques include drawing and annealing in a carburizing atmosphere although these procedures are not believed to have been used in combination in the production of welding electrode.

The metallurgical properties of welds generally have been discussed in a paper entitled “Effect of Carbon Content and Peritectic Reaction on Hot Cracking of Weld Metal of High Carbon Steel” authored by Koreaki Tamaki, Hiroshi Kawakami and Jippei Suzuki of the Department of Mechanical Engineering, Mie University, Kamihama-cho, Tsu, Mie, 514-8507, Japan. This paper provides general background, but does not directly relate to rail welding.

### SUMMARY OF THE INVENTION

In order to address the problem in the prior art of a fusion line of high hardness in the weld immediately adjacent a zone of low hardness in the rail, when graphed showing a dramatic valley and then peak before hardness levels, is accomplished in the invention with the use of a higher carbon welding electrode. While the problem in the prior art of alloyed steel of the migration of the carbon from the rail to the weld results in high hardness to the point of brittleness in one zone and low hardness to the point of softness in an adjacent zone, the use of a welding electrode which produces a weld deposit having carbon content of about 0.2% to 1.0% provides adequate resistance to carbon migration to avoid loss to the point of the achievement of desirable strength and hardness properties.

In a first embodiment, a series of steps of drawing and annealing in a carbon rich atmosphere enables the production of welding electrode having a final carbon content which produces a weld deposit of about 0.2 to 1.0%.

In an alternative embodiment, a composite welding electrode is formed using steel as one component and having granulated or powdered carbon deposited therein. In general configuration, this alternative has the steel formed in a generally tubular shape with the carbon present in the interior chamber defined by the walls of the tube. In terms of metal forming technique, generally a steel bar is grooved, the carbon deposited and the steel then drawn or otherwise formed around the deposited carbon.

### BRIEF DESCRIPTION OF THE DRAWINGS

FIG. 1 is a graph showing hardness plotted against distance across a weld fusion line.

FIG. 2 is a flow chart showing the drawing, annealing and carburizing steps.

FIG. 3 is a schematic showing the composite weld electrode.

FIG. 4 is a flow chart showing the forming of the rod of FIG. 3.

### DETAILED DESCRIPTION

High carbon welding electrode enables the welding of high carbon and high tensile steel pieces, such as railroad rails. When less than optimum welding electrode alloy is used, such as when using ordinary welding electrode used for joining ferrous material having a carbon content of 0.2% or less, it has been discovered that the fusion line between the material originating in the rail or work piece and the welding rod electrode a minute dimension having significantly different material properties is present. When a low carbon welding electrode has just solidified and is still at a high temperature, there is a tendency of the carbon molecules from the higher carbon steel rail to migrate from the rail to the weld material. This deprives the rail steel of high carbon, present or tensile strength, and adds unduly high carbon content to the welding electrode alloy at a temperature which, when cooled to ambient, results in a low strength and ductility in the rail and a high strength and brittleness in the immediately adjacent weld material. This fusion line of varying strengthed properties is exceedingly difficult to detect but results in a zone highly vulnerable to failure under high cyclic loads such as those imposed by running a train over rails.

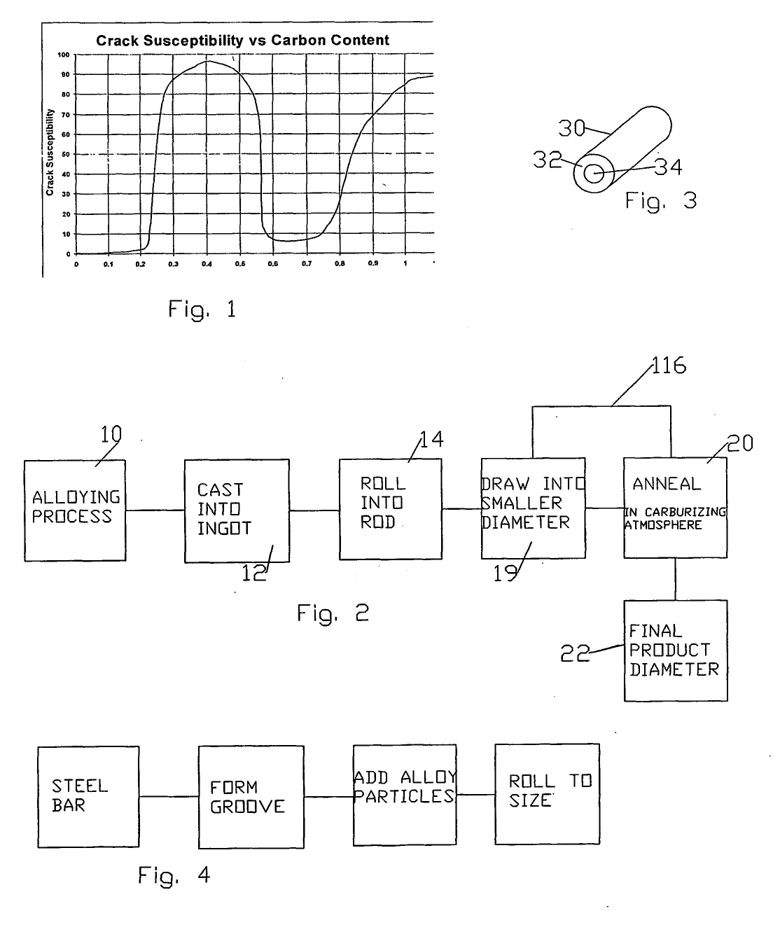

The graph in FIG. 1 generally shows this phenomenon as discussed in the Tamaki article. This is shown for illustration purposes, to show the crack susceptibility trends, not to provide quantification of specific materials. The experience with rail welds described herein is believed consistent.

Recent tests show that an optimum chemistry in a welding electrode which produces a deposit of 0.1% to 1.0% carbon, 1.8 to 2.0% manganese, 0.3 to 0.4% molybdenum, 0.05 to 0.06% nickel and 0.05 to 0.95% silicon, the balance of the alloy comprising iron, will resist the loss of carbon in the rail material and also have a weld material which will itself have adequate tensile strength.

The alloying materials should be present in the electrode itself, in higher proportions to account for loss in the welding operation as the plasma formed by welding causes disassociation of the materials. Thus in the electrode, the carbon should be a percentage of about 1.1% in a solid electrode to about 1.2% in a cored or composite electrode.

A difficulty in the use of this electrode is the difficulty in forming the rod in the first instance. Alloy, heat and forming processes all modify the material. Thus, the simple drawing of steel having a beginning alloy content in the proportions described above will result in a work hardening that prevents formation in the desired dimensions because of the brittleness imparted thereby. The annealing of the material will, in the ordinary instance, result in migration of a proportion of the carbon to the surface of the material, thereby resulting in a net loss of carbon from the surface as a result of the use of the material.

The forming of appropriate electrode of a desired dimension, such as 0.0625 inches is accomplished by a series of steps as shown in FIG. 2. An alloying process 10 is used to form an ingot 12 having a carbon content of about 0.20% or above. The ingot is formed 14 into rod of about 0.22 inches diameter and having a lower carbon content than the ingot from which it was produced, the loss being accounted for by the material process used. A series of steps 16 follow in which the rod is progressively drawn to form wire 18 of progressively smaller diameters, reducing by approximately 0.030 inches in each step, each reduction in diameter results in work hardening. The next step 20 combines annealing and carburizing. The drawn wire is annealed in a high carbon environment which therefore prevents carbon migration from the metal alloy. The combined annealing, carburizing step 20 is repeated until the drawing step 18 reduces the diameter to that desired as a finished diameter.

At the completion of the process it is expected that the finished electrode 22 will have a content in carbon which produces a weld deposit marginally below that of the electrode range. The electrode is then ready for use in gas shielded arc welding. Use of such a electrode in a welding process such as described herein or other rail welding processes may be expected to result in relatively uniform strength across the fusion line between the work piece and weld material.

In an alternative embodiment, a composite welding electrode 30 is formed and arranged as shown in FIG. 3. The metallic portion 32 of the welding electrode is formed generally as a tube, with carbon and alloying element particles 34 in a powdered/granulated form filling the chamber defined by the walls of the tube. Relative dimensions are such that the particles 34 comprise a mixture of materials having the requisite composition to result in the finished weld having the percentages described above, for example about 1.2% carbon, which when combined with the mild steel walls of the electrode during the welding operation will result in the desired concentration, within the ranges discussed above. In Gas Shielded Metal Arc Welding, using a solid electrode, an effective composition for the electrode is 0.1% to 1.0% carbon, 1.8-2.0% manganese, 0.30-0.40% molybdenum, 0.5%-0.6% nickel, 0.5% to 0.95% silicon and the balance being iron and trace elements.

In accordance with our invention, we claim:

1. A welding electrode comprising an elongated metal body formed primarily of iron alloyed with carbon in which the carbon content of the metal forming the body is greater than 0.1% by mass.

2. The welding electrode of claim 1 further comprising:
an electrode which, when heated above its melting point during a welding operation, provides a weld deposit having carbon content of about 0.55% to 0.95%.

3. A welding electrode formed by one of a series of steps of:
repeatedly drawing and annealing in a carbon rich atmosphere or enables, or grooving a steel bar, depositing deposited in a groove formed thereby, the steel then being formed around the deposited carbon.

4. The welding electrode of claim 3 further comprising:
using steel as one component and having granulated or powdered carbon deposited therein whereby the steel formed in a generally tubular shape with the carbon present in the interior chamber defined by the walls of the tube from a

5. The welding electrode of claim 2 further comprising:
said electrode forming a weld having substantially uniform strength and ductility across a weld between high strength material.

6. The welding electrode of claim 2 further comprising:
said welding electrode produces a deposit of 0.1% to 1.0% carbon, 1.8 to 2.0% manganese, 0.3 to 0.4% molybdenum, 0.05 to 0.06% nickel and 0.05 to 0.95% silicon, the balance of the alloy comprising iron.

7. The welding electrode of claim 1 further comprising:
the carbon content of the electrode about 1.1% in a solid electrode to about 1.2% in a cored or composite electrode.

8. The welding electrode of claim 1 further comprising:
said electrode comprising a diameter of 0.0625 inches.

9. The welding electrode of claim 3 further comprising:
forming an ingot having a carbon content of about 0.95%
forming said ingot into rod having a lower carbon content than the ingot from which it was produced;
drawing said rod progressively to form wire of progressively smaller diameters, reducing by approximately 0.030 inches in each step
annealing and carburizing said drawn wire is annealed in a high carbon environment after each progressive drawing step, until the drawing step reduces the diameter to that desired as a finished diameter.

10. The welding electrode of claim 10 further comprising:
said electrode comprising a diameter of 0.0625 inches.

11. The welding electrode of claim 10 further comprising:
said finished electrode having a content in carbon which produces a weld deposit of about 0.9% or within the 0.85 to 0.95% range.

12. The welding electrode of claim 3 further comprising:
a composite welding electrode formed and arranged so as to have a tubular metallic portion with ferric walls defining an elongated central chamber;
carbon and alloying element particles in a powdered/granulated form filling said chamber;
the relative dimensions of the walls and chamber are such that the particles comprise a mixture of materials having about 1.1% carbon.

13. The welding electrode of claim 13 further comprising:
said portion being formed of mild steel.

14. The welding electrode of claim 3 further comprising:
the carbon content of the electrode is about 1.1% in a solid electrode to about 1.2% in a cored or composite electrode.
